(19) United States
(12) Patent Application Publication
(10) Pub. No.: US 2013/0103502 A1
(43) Pub. Date: Apr. 25, 2013

(54) Method and Apparatus for Ad Insertion in Cellular Networks

(71) Applicants: Gunnar Mildh, Sollentuna (SE); Haseeb Akhtar, Garland, TX (US); Calin Curescu, Solna (SE); Ayodele Damola, Solna (SE); Jonas Högberg, Taby (SE); Jan-Erik Mångs, Solna (SE); Bob Melander, Sigtuna (SE); Hareesh Puthalath, Stockholm (SE); Lars Westberg, Enkoping (SE)

(72) Inventors: Gunnar Mildh, Sollentuna (SE); Haseeb Akhtar, Garland, TX (US); Calin Curescu, Solna (SE); Ayodele Damola, Solna (SE); Jonas Högberg, Taby (SE); Jan-Erik Mångs, Solna (SE); Bob Melander, Sigtuna (SE); Hareesh Puthalath, Stockholm (SE); Lars Westberg, Enkoping (SE)

(73) Assignee: TELEFONAKTIEBOLAGET LM ERICSSON (PUBL), Stockholm (SE)

(21) Appl. No.: 13/696,417

(22) PCT Filed: Mar. 5, 2012
(86) PCT No.: PCT/SE12/50244

§ 371 Date: Nov. 6, 2012

Related U.S. Application Data
(60) Provisional application No. 61/531,450, filed on Sep. 6, 2011.

(51) Int. Cl. G06Q 30/02

(52) U.S. Cl. CPC G06Q 30/0267
USPC 705/14.61; 705/14.64

(57) ABSTRACT

In one aspect, the present invention comprises a method or methods for introducing ad insertion and ad management into operator networks (Core Network or Radio Access Network), thereby improving ad management capabilities and avoiding the need for the operator to share internal network or UE information with third parties. In one or more embodiments, the contemplated method(s) and supporting apparatuses are applicable to scenarios where the network operator and a third-party ad provider have an agreement and where they do not.

### TECHNICAL FIELD

The present invention generally relates to electronic advertisements, and particularly relates to advertisement insertion and management in the context of cellular communication networks.

### BACKGROUND

Ads are used in many Internet services (e.g., web) and are a large source of revenue for content providers. Ad targeting represents one mechanism that holds significant promise in increasing the effectiveness of electronic advertising. Ad targeting includes selecting the right ad for the right user, increasing the ad effectiveness.

Current mechanisms for targeting and managing advertisements rely on information available at the ad provider, often referred to as Over The Top (OTT) information. The ad provider generally does not have detailed knowledge about the current location of a given user equipment (UE) or the associated user's subscription information, although such data is available to the cellular network supporting the UE—for example, such information is known or can be ascertained within a 3GPP network to which the UE is connected.

However, even in scenarios where the network operator and a third party ad provider have some form of agreement, the operator may be reluctant to share certain information for its subscribers with third parties, such as detailed subscription information, location data, etc. Such hesitancy stems from understandable privacy concerns regarding the subscribers, and from subscriber and network security concerns.

### SUMMARY

In one aspect, the present invention comprises a method or methods for introducing ad insertion and ad management into operator networks (Core Network or Radio Access Network), thereby improving ad management capabilities and avoiding the need for the operator to share internal network information with third parties. In one or more embodiments, the contemplated method(s) and supporting apparatuses are applicable to scenarios where the network operator and a third-party ad provider have an agreement and where they do not.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 illustrates one embodiment of an example 3GPP cellular network.

FIG. 2 illustrates an overview of one embodiment of a logical architecture for ad management in a Radio Access Network (RAN).

FIG. 3 provides additional example details for ad management architecture in a RAN.

FIG. 4 illustrates an example signaling procedure for ad insertion.

FIG. 5 illustrates an embodiment of a method of providing targeted advertising within the network of FIG. 1, for example.

### DETAILED DESCRIPTION

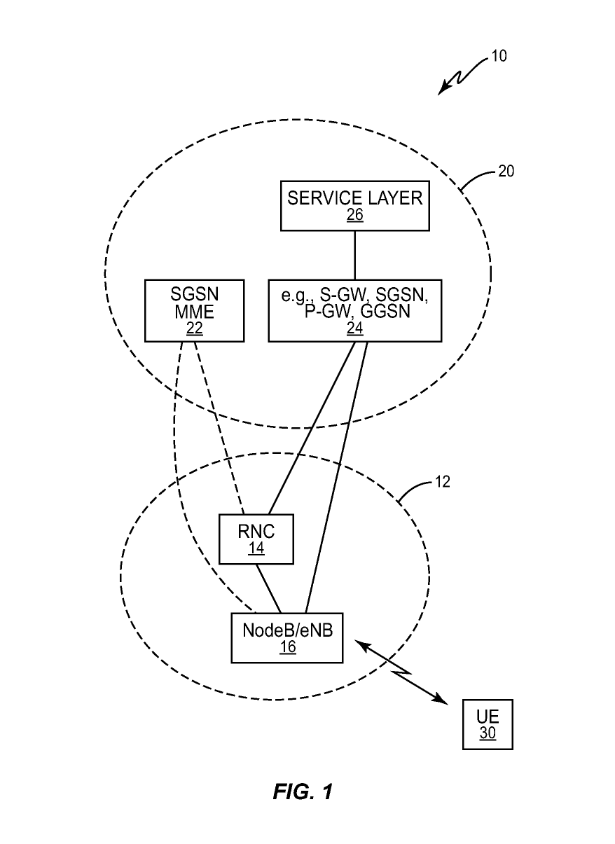

FIG. 1 depicts an example wireless communication network 10, e.g., a 3GPP-based cellular communication network comprising a number of nodes in a Radio Access Network (RAN) 12, such as Radio Network Controllers (RNCs) 14 and base stations 16 (e.g., NodeBs, eNodeBs, etc.), as well as a number of nodes in a Core Network (CN) 20, such as Mobility Management Entities (MMEs) 22, and one or more other nodes 24, such as Serving Gateways (S-GWs), Serving GPRS Support Nodes (SGSNs), Packet Gateways (P-GWs), Gateway GPRS Support Nodes (GGSNs). The figure further depicts one or more service layer nodes 26, such as Proxy nodes, Video coding nodes, etc.

Among other functions and features, the illustrated 3GPP network 10 provides Internet access to items of user equipment 30 (UE in the singular and UEs in the plural) that connect wirelessly through the RAN 12. Many of the example embodiments discussed herein focus on scenarios where the ad insertion and (or) ad management is (are) performed in the RAN 12. However, the present invention is equally applicable to scenarios where the insertion and (or) ad management is (are) performed in the CN 20 or at the Service Layer (SL) in the network 10.

As for introducing Core and Service Layer functionality in the RAN 12, one possible migration of 3GPP networks is to introduce service awareness in the RAN 12. This awareness can be achieved by moving Core and Service layer functionality (or physical nodes) to a RAN site, such as a Radio Network Controller, “RNC”, site or a base station site. Internal interfaces between the Core/Service layer and the RAN 12 would be specified accordingly.

Introducing such functionality at a RAN site advantageously enables ad insertion and ad management at the involved site. In turn, such capabilities make it possible for a UE 30 to stay connected to the same RAN site during mobility within and between Radio Access Technologies (RATs). Further, such capabilities make the IP layer available at the RAN site and that in turn allows IP-layer functions such as HTTP proxy, Caching, and Shallow and Deep Packet Inspection.

Such capabilities also make it possible to base the ad insertion on RAN/CN internal information. Examples of such internal network information that is known within the network 10 for any given UE 30 include:
UE location (e.g. Cell Location, Base Station, Tracking/Routing/Service/Location Area, Detailed GEO location, etc.);
subscription information or profiles (3GPP defined SPID, other information like Roaming Info, Customer Type, Subscription Type, etc.);
QoS aspects (Link performance, Traffic Statistics, Ongoing Services);
device capabilities (RAT support, max bit-rate, Screen size, Type of device (smart phone, laptop, etc.), 3GPP defined UE (radio) access capabilities);
network load conditions (radio load, transport load, etc.);
UE mobility or traffic history;
UE registered RAT (2G, 3G, LTE, WiMAX, Wifi), UE registered access point (macro, home, Wifi), etc.;
UE policies (allowed services, allows roaming etc.); and
various other items of information known within the network 10.

Alternatively, the contemplated advertising-related functions are provided via core and service layer functionality as retained at a defined CN site. In such cases, the implementation is adapted to handle internal network information, such as mobility, subscription information, etc.

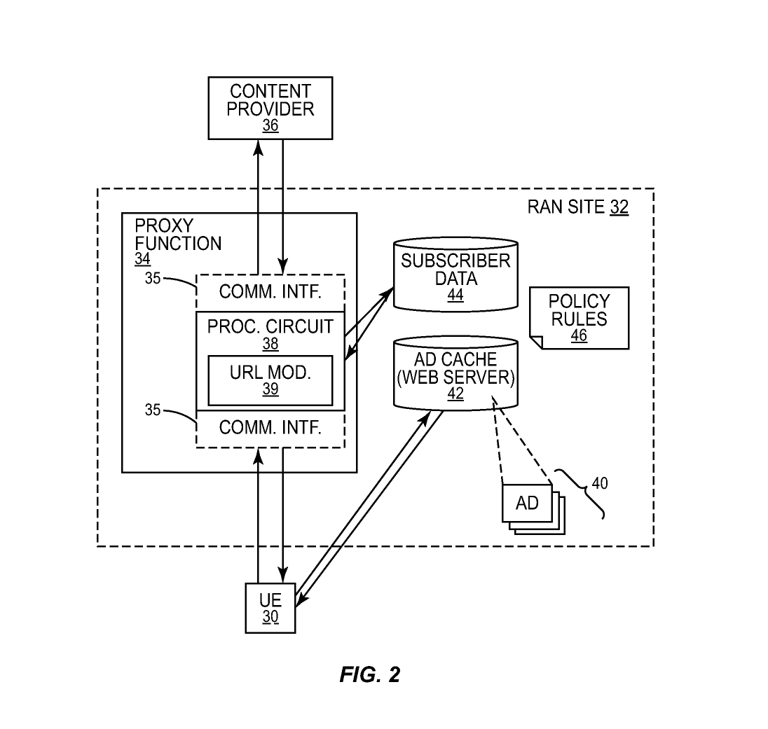

The following embodiments provide non-limiting example details for how ad insertion/management is performed using IP layer functions at a RAN site using RAN/CN specific information. In this regard, FIG. 2 illustrates an overview of an ad management architecture implemented in the RAN 12.

In particular, FIG. 2 depicts a RAN site 32, such as an RNC site or base station site, that includes Proxy functionality, shown as a proxy function 34, that intercepts signaling messages between a UE 30 and the content provider, depicted as a content provider 36, e.g., an origin server, such as a web server, that is owned by or associated with an advertiser. In at least one embodiment, the proxy function 34 proxies and intercepts many different protocols, such as HTTP, HTTPS, TCP, etc. To this end, the proxy function 34 includes one or more communication interfaces 35, which allow it to interface with other nodes in the network 10 and intercept and forward such signaling messages.

In at least one embodiment, the proxy function 34 is configured to modify the content of intercepted protocol messages. To intercept and modify such signaling messages going between the UE 30 and the content provider 36, the proxy function 34 includes a processing circuit 38. As a non-limiting example, such modifications include adding or modifying URLs. These operations and capabilities are, in an example configuration, implemented in a URL modifier 39 included in the processing circuit 38. For example, the URL modifier 39 allows the proxy function 34 to insert links to targeted advertisements that will be downloaded by the UE 30.

More broadly, the proxy function 34 is implemented in one or more nodes in the network 10 and it is configured to provide targeted advertisements to UEs 30 that are connected to the network 10. To provide such functionality, the one or more communication interfaces 35 of the proxy function 34 are configured to receive a signaling message going between a UE 30 and one or more content providers 36. These interfaces 35 may be, for example, the communication interfaces that are already implemented in the network node where the proxy function is located, e.g., base station interfaces that interconnect a base station with its supported UEs and with other nodes in the RAN 12 and/or in the CN 20.

In further configuration details, the processing circuit 38 includes the URL modifier 39 or other message modification circuit, and it is configured to recognize that the intercepted signaling message is associated with targeted advertising and to determine targeted advertisement information for the UE 30 as a function of the policy rules 46, which are parameterized using internal network information known within the network 10 for the UE 30. This parameterization can be understood as a dynamic process, which uses the latest available values of the involved parameters, so that over time the parameterization values change with changes in network conditions, UE service conditions, UE location, etc.

The processing circuit 38 is further configured to modify the intercepted signaling message according to the targeting advertisement information, to trigger delivery of a targeted advertisement to the UE 30. Here, as an example, the proxy function 38 can modify an intercepted web page request from the UE 30, or it can intercept and modify the corresponding response from the web server targeted by the request.

In at least one embodiment, the processing circuit 38 and the proxy function 34 at large are implemented using computer-based processing circuitry, such as one or more programmed digital processors. More generally, it will be understood that the network nodes or entities that implement the contemplated advertising functionality are, for example, computer-based equipment having one or more microprocessor circuits or other digital processing circuitry that is configured to perform the contemplated functions.

For example, a network node includes digital processing circuitry, such as a microprocessor-based circuit that includes or has access to memory or other computer-readable medium, where that medium stores program instructions the execution of which configure the digital processing circuitry according to the present invention. Such processing is implemented, for example, in conjunction with a local ad cache 42 or other database from which targeted ads or ad types are selected. That is, targeted advertisements may flow from external databases maintained by the content provider, or they may be delivered from the local ad cache 42, which contains a number of locally cached ads 40, which may be updated or rotated from time to time, or targeted advertising may rely on a mix, wherein targeted advertisements are taken from the local ad cache 42 when the selected ad is available therein, and otherwise are pulled or delivered from a database external to the network 10.

Further, the example network node, e.g., an RNC 14 or base station 16 that includes the proxy function 34, also includes or has direct or indirect access to internal network information, including subscriber information 44, which is processed for identifying/selecting targeted ads. The example node also includes or has direct or indirect access to policy rules 46 that are used to configure or otherwise control the behavior of the proxy function 34 in its performance of targeted advertising operations. The policy rules 46 are parameterized according to one or more items of the internal network information, meaning that variable components of that information drive the evaluation of policy rules 46 towards the selection of a particular advertisement or type of advertisement, to be targeted to any given UE 30 at any given time.

Regardless of the particular implementation details, the overall processing and functional architecture contemplated in one or more embodiments herein supports both web and HTTP video streaming sources, by modifying the resource description files (e.g. HTML, XML, M3U playlist, etc.) associated with these streams. In one embodiment, the modification adds ad-clips to HTTP streaming playlists, so that such ad-clips are displayed in the end-user video client, e.g., shown to a user via a video client running on a UE 30. Additionally or alternatively, ad-images (e.g. banners) are added to web pages displayed in a web browser of the UE 30. Other effects are also possible.

In at least one embodiment, the policy rules 46 for modifying the URLs and the resource description files are stored as a set of policy rules in the RAN 12. In at least one embodiment, the operator of the network 10 configures the policy rules 46, based on an internal configuration or agreement with third party ad providers. Further, the proxy function 34 in at least one embodiment modifies the URLs and the resource description files based on the RAN/CN information discussed in the previous section (e.g., UE location, subscription information or profiles, QoS aspects, etc.).

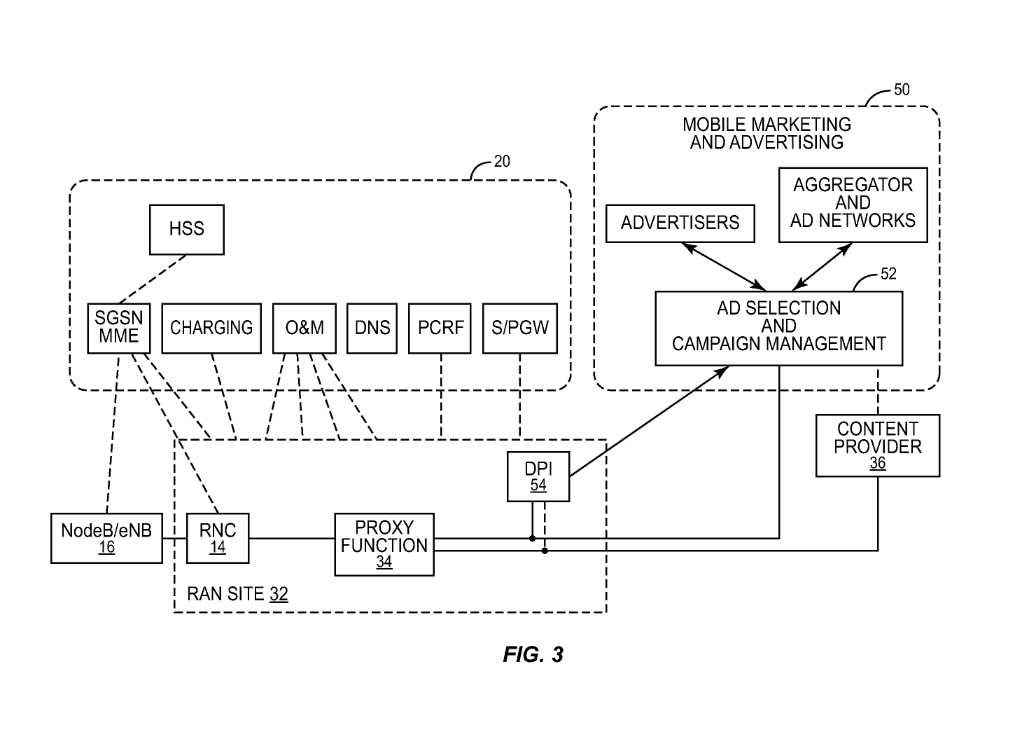

Notably, the ad management in the RAN 12 is in one or more embodiments a part of a larger ad management architecture as illustrated in FIG. 3. The illustrated example includes an ad management function 50, which may be a server or other computer-based node that includes an ad selection and campaign management function 52. The ad selection and campaign management function 52 uses data from advertisers and/or aggregator and ad networks.

In a more particular example embodiment, ad selection and campaign management function 52 manages targeted advertisements. In at least one embodiment, that function is configured to select which ads to use in targeted advertising, based on a number of criteria, such as date, time of day, number of shows per ad, previously shown ads, known customer information etc. In at least one such embodiment, the ad selection and campaign management function 52 is configured to inter-act with third-party ad networks and advertisers, for obtaining or otherwise providing more ads, and for exchanging charging information and other statistics etc.

Finally, in addition to proxy functionality via the proxy function 34, FIG. 3 also illustrates a deep packet inspection (DPI) function 54 that is included in the RAN site 32 in one or more embodiments. Deep packet inspection allows the RAN site 32 to classify ongoing services for a UE 30. In at least one embodiment, the classification capability is used to trigger ad insertion functionality, which also applies for non-proxied protocols.

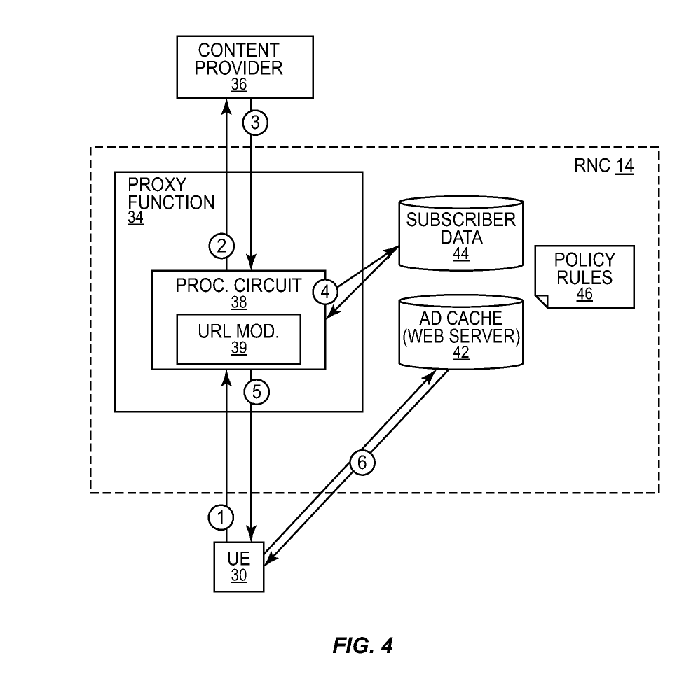

FIG. 4 illustrates example procedures/embodiments for ad insertion at an RNC 14, as a non-limiting example of the RAN site 32 introduced in FIG. 3. The diagram provides a contextual reference in the signaling procedures described below by way of its circled number designators, which correspond to example processing steps/actions that are included an embodiment of the present invention, or are contextually related to such processing.

In particular, FIG. 4 provides a reference for explaining an example procedure for inserting an ad into a web page. Of course, the example procedure applies equally to other content, such as video, audio, etc. The procedure is further extended in at least one embodiment herein, for improving the ad management capabilities. Such extensions are independent of each other and can be applied separately or together. The different components of the basic and extended procedures can also be varied and applied in different order.

With this implementation flexibility in mind, an example of a basic ad insertion procedure is as follows:
1. The UE 30 requests a web page (object) by sending an HTTP Get message;
2. The proxy function 34 passes the message on to the content provider 36;
3. The content provider 36 responds with an HTML file describing the web page;
4. Optional processing;
5. The proxy function 34 modifies the HTML file and inserts a URL reference to an ad (e.g., a clickable image having a URL link); and
6. The UE 30 decodes the HTML file and retrieves the ad object (e.g., an image, video clip);

In a first extension of the above procedure, in “Step 2,” the proxy function 34 inserts additional information (e.g. as meta data in the HTTP signaling) towards the content provider 36. This additional information assists the content provider 36 in constructing the web page. The additional information can include one or more of the following items:
information indicating that ad insertion is supported in network;
information about the subscriber (which advantageously may be made anonymous);
a reference number to the ongoing transaction to help further processing in the content provider 36 or proxy function 34;
relevant statistical information; and
other information related to the selection of targeted ads.

In another extension, which may be practiced independently from the first extension described immediately above, in “Step 3,” the content provider 36 inserts additional information (e.g. as meta data in the HTTP signaling) towards the proxy function 34. This additional information assists the proxy function 34 with ad insertion. The additional information can include one or more of the following items:
information indicating that ad insertion is allowed for this request;
information about the subscriber (which may be made anonymous);
a reference number to the ongoing transaction to help further processing in the content provider 36 or proxy function 34;
relevant statistics, etc.;
information (e.g. tags, markers) that helps the proxy function 34 to perform ad insertion (e.g. by marking ad content differently from other content); and
other information related to the selection of ads

In a third extension, which may be practiced independently from the other extensions, in “Step 4, “the proxy function 34 retrieves subscription data 44, as part of the internal network information, as well as policy rules 46, where that data is directly or indirectly accessible according to the RAN/CN functionality in the operator's network 10.

In a particular example embodiment for using RAN/CN specific information, such as subscriber data 44 and/or policy rules 46, it first should be understood that RAN/CN specific information can be used advantageously to enhance ad targeting in the case of ad insertion in the operator network. Consider location information as one example.

The RAN/CN layers of a cellular network have detailed information about UE position. In a simple example, the network 10 at least “knows” the current cell ID of each UE 30 being supported by the network 10. Such information is readily available and can be retrieved without suffering the extra complexity or delay associated with using OTT or UE-based positioning methods (e.g., GPS). With the location information available to it, a network operator can provide ads of local advertisers, thus improving ad targeting. For example an ad for a specific car brand links to a local car dealership that sells that particular car.

Consider subscription information as another example. The network operator has access to large amounts of subscription information for its subscribers. Example data include demographically interesting items, such as age or age group, sex, income, household status, etc. In at least one embodiment, the contemplated ad selection function implemented by the proxy function 34 processes subscriber information to identify targeted advertisements. For example, targeting parameters may be defined for certain ads, such as target age range, income level, etc., and ad selection therefore comprises in one or more such embodiments processing the subscriber information to identify subscribers having parameters that match one or more of the targeting parameters.

Further, the network 10 knows which UEs 30 are roaming (nationally and internationally). In at least one embodiment contemplated herein, such information is used to target specific ads towards roamers (e.g. tourist attractions).

In a further embodiment, the network 10 is configured to support different types of subscriptions, such as where the subscriber associated with a given UE 30 has a wholly or partially ad-based subscription agreement where the monthly subscription fees to the subscriber are offset or eliminated based on the subscriber agreeing to receive some number of targeted advertisements during network usage. This feature also allows the network operator to offer potentially more expensive subscription types that wholly partly or eliminates advertising.

Consider device capabilities as another example. Subscribers typically use a wide variety of device types to access network-provided communication services and these different types of UEs 30 have a potentially wide range of capabilities, e.g., in terms of supported data rates, supported protocols, the type and sophistication of device-supported client applications, screen sizes, multi-media capabilities, etc. Thus, in one embodiment of ad targeting as contemplated herein, the internal network information includes information indicating device capabilities, e.g., screen size, device type (laptop, smart phone). This information is stored as subscription information or can be retrieved from 3GPP UE (radio) access capabilities, or IMEI, or software version information. The proxy function 34 uses such information to carry out the contemplated ad selection and insertion functions, e.g., by selecting different ads for different UEs 30 with different screen sizes or processing capabilities.

As another example, consider the current Radio Access Technology, “RAT”, and network load. The RAN 12/CN 20 know which RAT is being used by any given UE 30 that is connected to the network 10, and they also have knowledge of the current network load, at least with respect to the service area(s) in which the UE 30 is currently located. In one embodiment, the ad selection and insertion function implemented by the proxy function 34 uses such information to choose different quality ads based on the achievable bit rates of each RAT and/or based on current network loading. As a non-limiting example of such selection and targeting, lower-quality ads are selected during periods of high loading, while higher-quality ads are selected during periods of lower loading. As just one advantage, such processing avoids additional delays for RATs with low bit rates.

Further, for ensuring quality of service (or experience) for ad content, it is recognized herein that solutions providing ad insertion at the RAN 12 can yield higher quality of service for the delivery of the ad content to UEs 30. This higher quality in turn improves the quality of experience (e.g., low delay) for the end user of operator-controlled ads, compared to over-the-top provided ads.

FIG. 2 introduced an example approach contemplated herein for improving ad delivery performance, wherein an ad cache 42 in the RAN 12 caches ads 40 that can be selected for delivery to end-users (individual UEs 30), based on one or more of the ad targeting parameters described herein. This approach reduces latency by delivering locally cached versions of the targeted ads 40, and from the overall perspective of the network 10, local caching of ad content lowers in some sense the transmission requirements needed for delivering ad content to UEs 30. Further enhancements are possible by directing the ad content to be downloaded over a higher priority radio bearer. This operation can be performed in the RAN 12 (e.g. in the downlink) based on knowledge of the ad content.

With the above in mind, a non-limiting advantage of the present invention is that it provides enhanced ad insertion and ad management capabilities. In turn, these capabilities make it possible to consider (for ad targeting) detailed RAN and CN parameters, such as Cell Location, Subscription Information or Profile, QoS aspects, Device Capabilities, Network Load, UE history information, UE registered Radio Access Technology (2G, 3G, LTE, WiMAX, WiFi), etc.

These features together increase the accuracy of the ad targeting mechanism. In turn, better ad targeting leads to increased revenues for the network operator, ad providers and ad buyers. Another advantage of the present invention is that the enhanced ad targeting capabilities provided by it are internal to the operator's network 10, which avoids the need to expose detailed internal network information to ad providers or other third parties. Yet another advantage of the present invention is that it provides a mechanism for prioritizing ad content, thereby improving the quality of service (or experience) of the ad content. As an example, the involved radio and transport networks employ a Quality-of-Service, “QoS”, mechanism, e.g., one based on packet marking, and prioritized radio scheduling. Thus, the network 10 may provide, as a non-limiting example of ad prioritization, prioritized scheduling for the radio transmission of packets associated with targeted ads. Of course, it is contemplated herein that such an approach would use the fact that a given packet or packets were ad-related as just one in a number of weighting factors considered by the radio scheduler.

Thus, one or more embodiments herein contemplate a method and apparatus implemented in the network 10, wherein the network 10 prioritizes advertising by giving a scheduling priority to transmit data that is marked or otherwise indicated as comprising a targeted advertisement. Prioritization may be performed on transport network links and/or in the RAN for radio link scheduling. In a non-limiting example, the proxy function 34 is at least partly implemented at a RAN site 32, where that RAN site includes a radio scheduler that is included in or operably associated with the proxy function (34) and which is configured to perform transmit scheduling on one or more radio links to UEs 30 and further to prioritize transmit data that is marked or otherwise indicated as belonging to a targeted advertisement.

In general, the targeted advertising functionality offers significant advantages through its use of internal network information known for UEs 30 operating within the network 10. Using internal network information known within the network 10 but not generally known outside the network, e.g., not known to third-party content providers, offers key advantages for delivering targeted advertising to UEs 30 operating in the network 10. For example, with the present invention, advertisement targeting can be based on current radio link and/or network loading conditions, among other parameters that are usually known exclusively within the network 10. Even if such parameters could be provided outside of the network 10 to drive advertisement selection, doing so would be impractical from a timing and signaling-overhead perspective, and would have potentially significant risks in terms of exposing sensitive subscriber and network operator information.

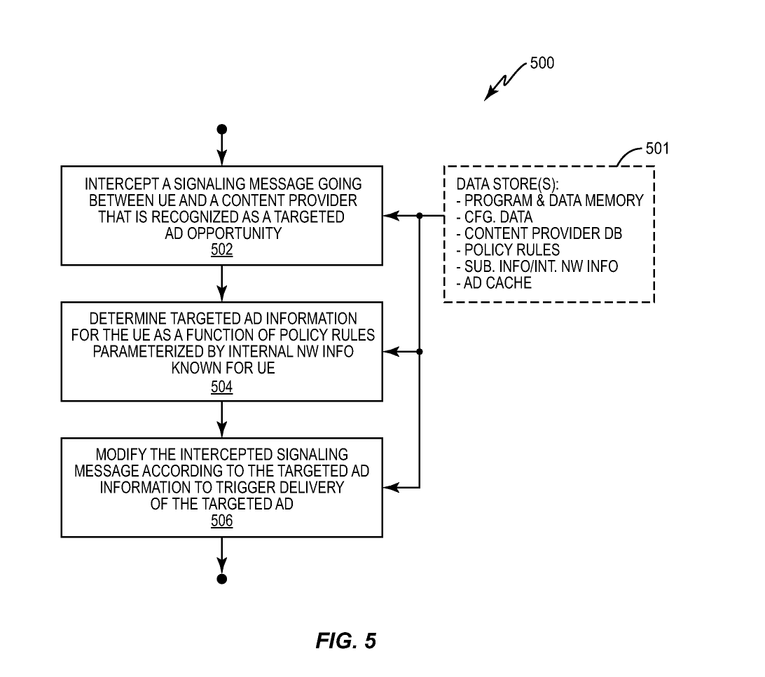

The present invention therefore advantageously provides for a rich parameterization of the policy rules used to select particular advertisements or types or formats of particular advertisements, for particular subscribers of the network 10, based on current, dynamically changing internal network information known for the UEs 30 of those subscribers. Further, the present invention does so without requiring such information to be sent outside of the network 10. FIG. 5 illustrates an embodiment of the contemplated method and it will be understood that, as a non-limiting example, the processing circuit 38 of the proxy function 34 shown in FIG. 2 implements the method 500 of FIG. 5, e.g., based in whole or in part on its execution of stored computer program instructions that programmatically configure the proxy function 34 to carry out the illustrated method.

One also sees that the method 500 makes use of various items of information stored in one or more data stores 501. It will be understood that these data stores 501 may comprise non-volatile data storage of one or more types, e.g., disk, memory, etc., and that such data stores may be included in the proxy function 34, or may be accessible to the proxy function 34 directly or indirectly. For example, one or more other nodes in the network 10 may provide the proxy function 34 with some of the indicated information.

In any case, the method 500 is implemented in the wireless communication network 10 and provides targeted advertising to UEs 30 connected to the network 10. More particularly, the method 500 according to the illustrated embodiment includes intercepting a signaling message between a UE 30 and a content provider that is recognized as being associated with targeted advertising (Block 502). For example, with momentary reference to FIG. 2, the processing circuit 38 of the proxy function 34 may be programmed to detect web page requests or other types of information requests that are directed to specific third parties. In one such implementation, the processing circuit 38 operates at the IP layer and looks for web page requests directed to specific web servers e.g., specific URLs associated with content providers 36 that are participating in targeted advertising according to a content provider database or configuration information known to the proxy function 34.

The method 500 continues with determining targeted advertising information for the UE 30 as a function of the policy rules 46 shown in FIG. 2, as parameterized by the internal network information known for the UE 30 (Block 504). For example, the policy rules 46 may include a rule such as: If content provider is W and UE is of type X and UE serving cell ID is Y, then selected advertisement is Z. Here, the italicized and underlined variables are parameters that are filled in with the corresponding values from the internal network information that is current for the UE 30. Note that the rules may be compound or chained, and that many other parameters may be considered in addition to these examples, or as an alternative to these examples.

Determining the targeted advertising information thus may comprise selecting the specific advertisement to be delivered to the UE 30, or may comprise forming information elements, “IEs”, or other data items to be sent to the content provider 36 of the involved content provider, so that the content provider's web server or the like performs the actual ad selection as guided by the proxy function 34. Thus, the method 500 continues with modifying the intercepted signaling message according to the targeted advertisement information, to trigger delivery of the targeted advertisement to the UE 30 (Block 506).

In one embodiment, the method 500 reduces to intercepting a web page request from the UE 30, recognizing that the web page request is targeted to a content provider for which targeted advertising processing should be performed, and correspondingly modifying the intercepted web page request or the corresponding web page request response from the content provider, to trigger delivery of the appropriate targeted advertisement to the UE 30. For example, the proxy function 34 intercepts the web page request going from the UE 30 to the content provider and modifies the corresponding response from the content provider, to include one or more dynamically inserted URLs or other links to the targeted advertisement, so that the UE 30 will download the targeted advertisement automatically, when processing the response. As shown in FIG. 2, the proxy function 34 and its included processing circuit 38 may perform such operations by operating at the IP layer and functioning as an HTTP proxy within the network 10.

In one or more embodiments of the above method 500, recognizing that the intercepted signaling message is associated with targeted advertising comprises recognizing that the signaling message is targeted to one in a number of content providers that are identified in configuration information known to the network 10. As noted, in at least one embodiment, the intercepted signaling message is a web page request from the UE 30 to a web server, or is a corresponding web page response from the web server to the UE 30, and modifying the intercepted signaling message comprises modifying the web page request before forwarding it toward the web server, to trigger the web server to include the targeted advertisement in the corresponding web page response, or to include a link to the targeted advertisement in the corresponding web page response, or to include information in the corresponding web page response directing the wireless communication network to select the targeted advertisement for delivery to the UE. Alternatively, such modification comprises modifying the corresponding web page response before forwarding it toward the UE 30, to include the targeted advertisement or to include a link to the targeted advertisement.

In at least one embodiment of the method 500, the internal network information includes one or more of the following items: UE location information comprising cell or base station ID and/or routing or service location area ID for the UE 30; subscription information or a user profile for the UE 30; quality-of-service information for the UE 30; current radio conditions of the UE 30; device capabilities of the UE 30; radio access capabilities of the UE 30; current network loading information; a mobility or traffic history of the UE 30; the current radio access technology in use by the UE 30; the type of access point through which the UE 30 is connected to the network 10; and UE policy information controlling allowed services or roaming for the UE 30.

In the same or another embodiment of the method 500, determining the targeted advertisement information in Block 504 comprises selecting the targeted advertisement based on the content provider and the policy rules, as parameterized by the internal network information. In a particular example, the determination is based on internal network information comprising at least one of the following: a current location of the UE 30 as expressed in terms of a cell or service area ID; current radio link conditions of the UE 30; and known device capabilities of the UE 30.

Further, in at least one embodiment of the method 500, modifying the intercepted signaling message as shown in Block 506 comprises modifying an HTML file returned from a web server of a content provider in response to a web page request sent from the UE 30 to the web server. In particular, the modification includes inserting one or more links to the targeted advertisement in the HTML file before forwarding it toward the UE 30. In a notable but non-limiting example, the proxy function 34 has access to a local cache of advertisements—see the cache 42 of ads 40 shown in FIG. 2—and it delivers the selected advertisement from the local cache. Such delivery has the advantage of saving overall bandwidth within the network, as the targeted advertisement does not need to be streamed all the way from the content provider. In a particular example of this approach, the proxy function 34 is implemented at a RAN site 32, such as is shown in FIG. 2, and advertisements may be sent to UEs 30 from a local ad cache 42 available to the RAN site 32, therefore avoiding the need to stream those ads from the content provider through the CN 20.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-24. (canceled)

25. A method in a wireless communication network of providing a targeted advertisement to a User Equipment (UE) connected to said wireless communication network, said method comprising:
intercepting a signaling message between the UE and a content provider that is recognized as being associated with targeted advertising;
determining targeted advertisement information for the UE as a function of policy rules that are parameterized using internal network information known within the wireless communication network for the UE; and
modifying the intercepted signaling message according to the targeting advertisement information, to trigger delivery of a targeted advertisement to the UE.

26. The method of claim 25, wherein the wireless communication network includes a proxy function that is configured to perform the method.

27. The method of claim 25, further comprising recognizing that the intercepted signaling message is associated with targeted advertising by detecting that the signaling message is targeted to one in a number of content providers that are identified in configuration information known to the wireless communication network.

28. The method of claim 25, wherein the intercepted signaling message is a web page request from the UE to the content provider, or is a corresponding web page response from the content provider to the UE, and wherein modifying the intercepted signaling message comprises one of:
modifying the web page request before forwarding it toward the content provider, to trigger the content provider to include the targeted advertisement in the corresponding web page response, or to include a link to the targeted advertisement in the corresponding web page response, or to include information in the corresponding web page response directing the wireless communication network to select the targeted advertisement for delivery to the UE; or
modifying the corresponding web page response before forwarding it toward the UE, to include the targeted advertisement or to include a link to the targeted advertisement.

29. The method of claim 25, wherein a proxy function implemented in the wireless communication network performs the interception of the signaling message.

30. The method of claim 29, wherein the proxy function is located in a network node included in the wireless communication network, the network node being a Radio Access Network (RAN) node of the wireless communication network, or a Core Network (CN) node of the wireless communication network.

31. The method of claim 25, wherein the internal network information includes one or more of the following items: UE location information comprising cell or base station ID; routing or service location area ID for the UE; subscription information or a user profile for the UE; quality-of-service information for the UE; current radio conditions of the UE; device capabilities of the UE; radio access capabilities of the UE; current network loading information; a mobility or traffic history of the UE; the current radio access technology in use by the UE; the type of access point through which the UE is connected to the wireless communication network; and UE policy information controlling allowed services or roaming for the UE.

32. The method of claim 25, wherein determining the targeted advertisement information comprises selecting the targeted advertisement based on the content provider and the policy rules, as parameterized by the internal network information.

33. The method of claim 32, wherein the internal network information comprises at least one of the following: a current location of the UE as expressed in terms of a cell or service area ID; current radio link conditions of the UE; and known device capabilities of the UE.

34. The method of claim 25, wherein modifying the intercepted signaling message comprises modifying an HTML file returned from the content provider in response to a web page request sent from the UE to the content provider, said modifying comprising inserting one or more links to the targeted advertisement in the HTML file before forwarding it toward the UE.

35. The method of claim 34, further comprising delivering the targeted advertisement out of a local cache of advertisements maintained in the wireless communication network.

36. The method of claim 25, wherein the method further comprises prioritizing advertising by giving a scheduling priority to transmit data that is marked or otherwise indicated as comprising a targeted advertisement.

37. A proxy function implemented in one or more nodes in a wireless communication network, said proxy function configured to provide a targeted advertisement to a User Equipment (UE) connected to said wireless communication network and comprising:
one or more communication interfaces configured to receive a signaling message going between the UE and a content provider; and
a processing circuit, including a message modification circuit, that is configured to:
recognize that the signaling message is associated with targeted advertising;
determine targeted advertisement information for the UE as a function of policy rules that are parameterized using internal network information known within the wireless communication network for the UE; and
modify the intercepted signaling message according to the targeting advertisement information, to trigger delivery of a targeted advertisement to the UE.

38. The proxy function of claim 37, further comprising a computer-readable medium storing said policy rules.

39. The proxy function of claim 37, further comprising a cache of locally stored advertisements, and wherein the proxy function is further configured to select the targeted advertisement from the cache of locally stored advertisements.

40. The proxy function of claim 37, wherein the proxy function is at least partly implemented in a Radio Access Network (RAN) node of the wireless communication network, or in a Core Network (CN) node of the wireless communication network.

41. The proxy function of claim 37, wherein the processing circuit of the proxy function is configured to recognize that the intercepted signaling message is associated with targeted advertising based on being configured to recognize that the signaling message is targeted to one in a number of content providers that are identified in configuration information known to the proxy function.

42. The proxy function of claim 37, wherein the intercepted signaling message is a web page request from the UE to the content provider, or is a corresponding web page response from the content provider to the UE, and wherein the processing circuit of the proxy function is configured to modify the intercepted signaling message based on being configured to do one of:
modify the web page request before forwarding it toward the content provider, to trigger the content provider to include the targeted advertisement in the corresponding web page response, or to include a link to the targeted advertisement in the corresponding web page response, or to include information in the corresponding web page response directing the wireless communication network to select the targeted advertisement for delivery to the UE; or
modify the corresponding web page response before forwarding it toward the UE, to include the targeted advertisement or to include a link to the targeted advertisement.

43. The proxy function of claim 37, wherein the internal network information includes one or more of the following items: UE location information comprising cell or base station ID or routing or service location area ID for the UE; subscription information or a user profile for the UE; quality-of-service information for the UE; current radio conditions of the UE; device capabilities of the UE; radio access capabilities of the UE; current network loading information; a mobility or traffic history of the UE; the current radio access technology in use by the UE; the type of access point through which the UE is connected to the wireless communication network; and UE policy information controlling allowed services or roaming for the UE.

44. The proxy function of claim 37, wherein the processing circuit of the proxy function is configured to determine the targeted advertisement information based on being configured to select the targeted advertisement based on the content provider and the policy rules, as parameterized by the internal network information known for the UE.

45. The proxy function of claim 44, wherein the internal network information comprises at least one of the following: a current location of the UE as expressed in terms of a cell or service area ID; current radio link conditions of the UE; and known device capabilities of the UE.

46. The proxy function of claim 37, wherein the processing circuit of the proxy function is configured to modify the intercepted signaling message based on being configured to modify an HTML file returned from the content provider in response to a web page request sent from the UE to the content provider, including inserting one or more links to the targeted advertisement in the HTML file before forwarding it toward the UE.

47. The proxy function of claim 46, wherein the processing circuit of the proxy function is configured to deliver the targeted advertisement out of a local cache maintained in the wireless communication network.

48. The proxy function of claim 37, wherein the proxy function includes or is operably associated with a radio scheduler in a Radio Access Network (RAN) node, and wherein the radio scheduler is configured to prioritize advertising by giving a scheduling priority to transmit data that is marked or otherwise indicated as comprising a targeted advertisement.
